(19) United States
(12) Patent Application Publication
(10) Pub. No.: US 2026/0359246 A1
(43) Pub. Date: Nov. 12, 2026

(54) PATH PROVISION SUPPORT APPARATUS, PATH PROVISION SUPPORT METHOD AND PROGRAM

(71) Applicant: NTT, Inc., Tokyo (JP)

(72) Inventors: Yoshifumi KATO, Tokyo (JP); Yu MIYOSHI, Tokyo (JP)

(21) Appl. No.: 19/129,899

(22) PCT Filed: Dec. 27, 2022
(86) PCT No.: PCT/JP2022/048329

§ 371 Date: May 14, 2025

(51) Int. Cl. G06F 13/40; G06N 7/01

(52) U.S. Cl. CPC G06F 13/4027; G06N 7/01

(57) ABSTRACT

A path provision support apparatus supports in improving the efficiency in the provision of a network transmission path by including: a selection unit configured to execute probabilistic selection of a plurality of pairs of first two nodes from among a plurality of nodes in a physical network, based on data indicating a likelihood of each of the plurality of nodes being selected as an endpoint of a logical transmission path set in the physical network; a route search unit configured to search, for each of the pairs of first two nodes, for a route capable of connecting the pair of first two nodes in the physical network; and a secured number adjustment unit configured to change a secured number that is the number of transmission paths to be secured in advance, for a pair of second two nodes through which the routes pass by a number satisfying a predetermined condition among all pairs of second two nodes out of the plurality of nodes.

### TECHNICAL FIELD

The present invention relates to a path provision support apparatus, a path provision support method, and a program.

### BACKGROUND ART

A transmission path for a physical network is set according to an order from a user. Before the provision of the path, time is required to perform route design, input settings into a device, and wait for the optical output level of the device to stabilize.

Conventionally, as a method to speed up order processing, a technique has been proposed to define commands that can be input in parallel and to shorten command processing until the path is opened (e.g., Patent Literature 1).

### CITATION LIST

### Patent Literature

Patent Literature 1: JP 2012-253582 A

### SUMMARY OF INVENTION

### Technical Problem

However, the main focus of the technology described in Patent Literature 1 is to shorten the path construction setting after receipt of an order, and it is difficult to provide a path on demand because time is required to perform route design and generate a construction procedure after receipt of an order.

It is also conceivable to secure a ground path between any two points in advance by a full-mesh path. In this case, any order can be handled immediately, but the amount of resources secured becomes enormous, and paths that are difficult to use are always secured, making resource utilization inefficient and impractical.

Thus, it has conventionally been difficult to rapidly provide a path in a situation where the starting and ending points of the order are unknown.

The present invention has been made in view of the above, and an object thereof is to support in improving the efficiency in the provision of a network transmission path.

### Solution to Problem

Therefore, to solve the above problem, a path provision support apparatus includes: a selection unit configured to execute probabilistic selection of a plurality of pairs of first two nodes from among a plurality of nodes in a physical network, based on data indicating a likelihood of each of the plurality of nodes being selected as an endpoint of a logical transmission path set in the physical network; a route search unit configured to search, for each of the pairs of first two nodes, for a route capable of connecting the pair of first two nodes in the physical network; and a secured number adjustment unit configured to change a secured number that is the number of transmission paths to be secured in advance, for a pair of second two nodes through which the routes pass by a number satisfying a predetermined condition among all pairs of second two nodes out of the plurality of nodes.

### Advantageous Effects of Invention

It is possible to support in improving the efficiency in the provision of a network transmission path.

### BRIEF DESCRIPTION OF DRAWINGS

FIG. 1 is a diagram illustrating a hardware configuration example of a path provision support apparatus 10 in an embodiment of the present invention.

FIG. 2 is a diagram illustrating a functional configuration example of the path provision support apparatus 10 according to the embodiment of the present invention.

FIG. 3 is a flowchart for explaining an example of a processing procedure executed by the path provision support apparatus 10.

FIG. 4 is a diagram illustrating a first example of network information.

FIG. 5 is a diagram illustrating a second example of the network information.

FIG. 6 is a diagram illustrating a configuration example of demand prediction source data.

FIG. 7 is a diagram for explaining a relationship between an edge and a path.

FIG. 8 is a diagram illustrating simulation parameters.

FIG. 9 is a diagram for explaining the stocked number of paths.

FIG. 10 is a diagram illustrating a configuration example of a recorded data storage unit 124.

FIG. 11 is a diagram illustrating a path stock status in an initial state.

FIG. 12 is a diagram for explaining a route search using only a path stock.

FIG. 13 is a diagram for explaining a path shortage.

### DESCRIPTION OF EMBODIMENTS

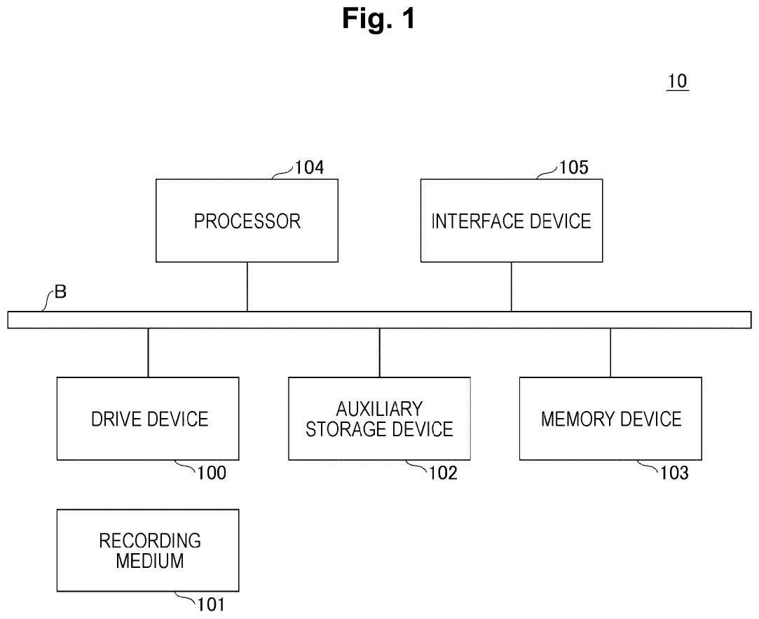

Hereinafter, an embodiment of the present invention will be described with reference to the drawings. FIG. 1 is a diagram illustrating a hardware configuration example of a path provision support apparatus 10 in an embodiment of the present invention. The path provision support apparatus 10 of FIG. 1 includes a drive device 100, an auxiliary storage device 102, a memory device 103, a processor 104, an interface device 105, and the like, which are connected to each other by a bus B.

A program for implementing processing in the path provision support apparatus 10 is provided by a recording medium 101 such as a compact disc read-only memory (CD-ROM). When the recording medium 101 that stores the program is set in the drive device 100, the program is installed from the recording medium 101 to the auxiliary storage device 102 via the drive device 100. However, the program is not necessarily installed from the recording medium 101 and may be downloaded from another computer via a network. The auxiliary storage device 102 stores the installed program and also stores required files, data, and the like.

When a command to start the program is issued, the memory device 103 reads the program from the auxiliary storage device 102 and stores the program. The processor 104 is a central processing unit (CPU), a graphics processing unit (GPU), or a CPU and GPU and executes a function regarding the path provision support apparatus 10 according to the program stored in the memory device 103. The interface device 105 is used as an interface for connection to the network.

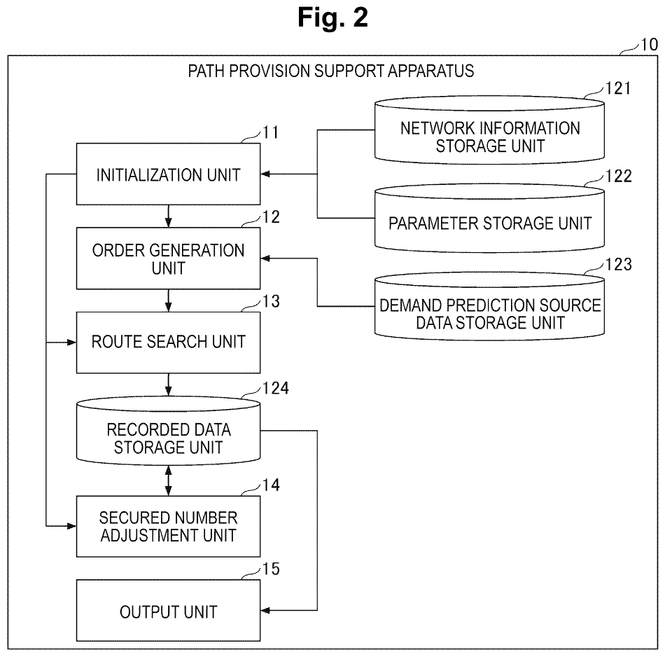

FIG. 2 is a diagram illustrating a functional configuration example of the path provision support apparatus 10 according to the embodiment of the present invention. In FIG. 2, the path provision support apparatus 10 includes an initialization unit 11, an order generation unit 12, a route search unit 13, a secured number adjustment unit 14, and an output unit 15. Each of these units is implemented by one or more programs installed in the path provision support apparatus 10 causing the CPU 104 to execute processing. The path provision support apparatus 10 also uses a network information storage unit 121, a parameter storage unit 122, a demand prediction source data storage unit 123, and a recorded data storage unit 124. Each of these storage units can be implemented by using, for example, the auxiliary storage device 102, a storage device connectable to the path provision support apparatus 10 via a network, or the like.

The path provision support apparatus 10 probabilistically generates a path order using the functional configuration illustrated in FIG. 2, and executes a simulation for predicting which transmission path (hereinafter simply referred to as a “pass”) is to be preset in a physical network subject to a path order (hereinafter referred to as a “target network”) allowing for rapid handling of an actual path order. In other words, the path provision support apparatus 10 selects a path that, if preset, allows for rapid handling of an actual path order.

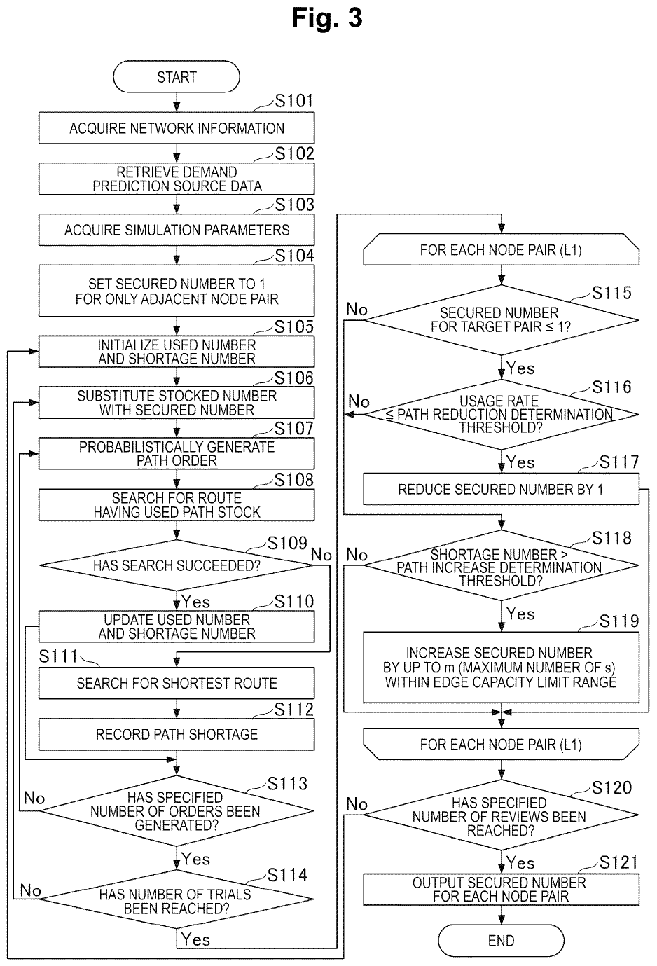

Hereinafter, a processing procedure executed by the path provision support apparatus 10 will be described. FIG. 3 is a flowchart for explaining an example of the processing procedure executed by the path provision support apparatus 10.

In step S101, the initialization unit 11 acquires the network information of the target network from the network information storage unit 121.

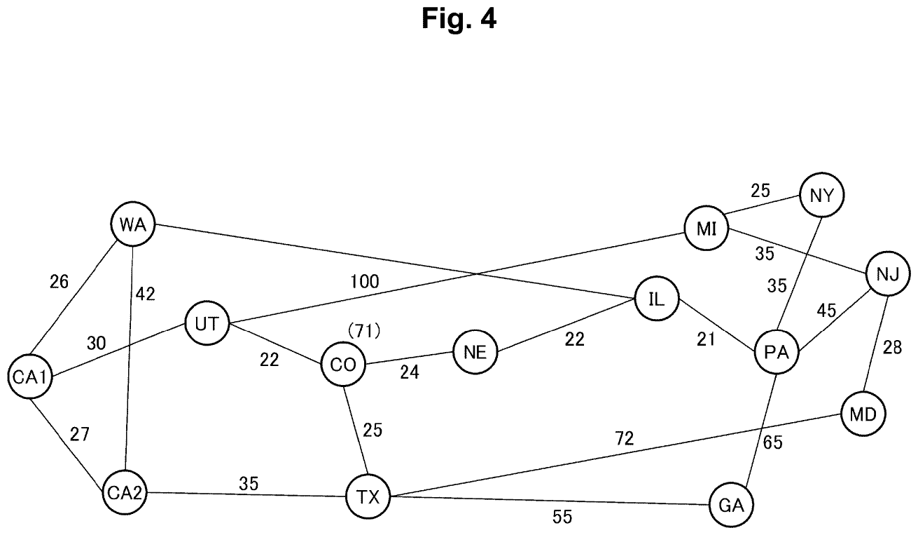

FIG. 4 is a diagram illustrating a first example of the network information. The network information is information indicating a topology or the like of the target network. In FIG. 4, the network information is represented using a graph including a plurality of nodes and edges that connect between the nodes. In the graph, a node is, for example, a city or a region where a data center or the like is disposed. An edge is a physical line connecting nodes. A numerical value set for the edge is the distance of the edge (the distance between the nodes connected by the edge).

Note that the network information may be represented in a structure other than the graph structure as long as the content illustrated in FIG. 4 can be represented.

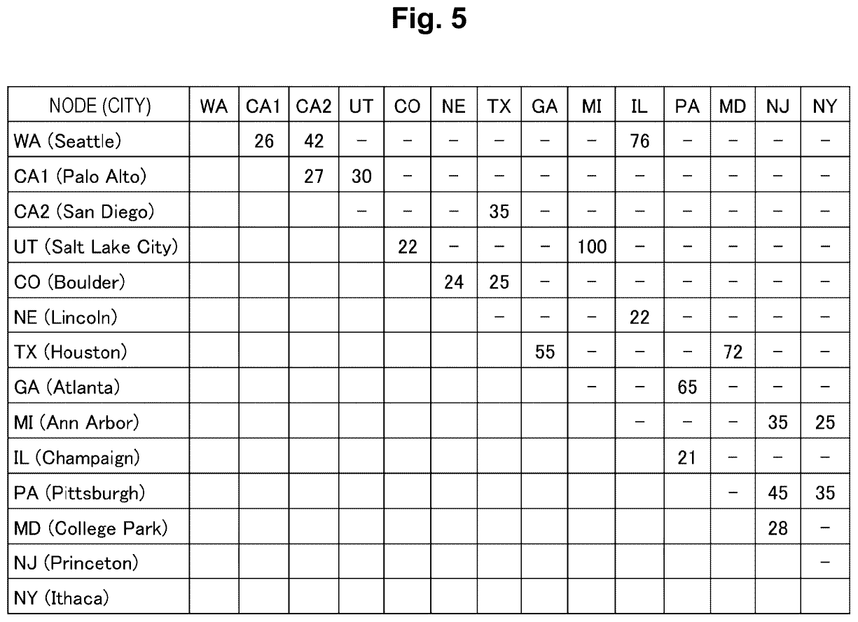

FIG. 5 is a diagram illustrating a second example of the network information. In FIG. 5, the network information is represented in a matrix format. An element (component) having a value indicates that a node in the row of the element and a node in the column are connected by an edge having the value as a distance.

Subsequently, the order generation unit 12 acquires demand prediction source data from the demand prediction source data storage unit 123 (S102).

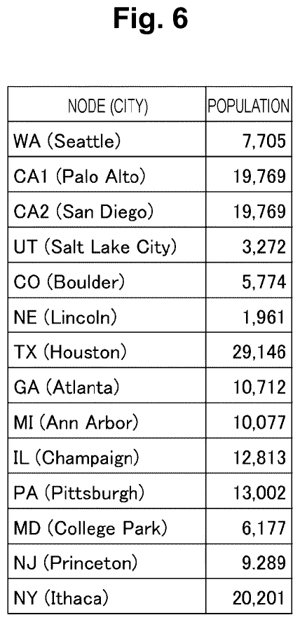

FIG. 6 is a diagram illustrating a configuration example of the demand prediction source data. The demand prediction source data refers to data used to predict a likelihood of being selected as an endpoint of a path in the path order (the level of demand for the path order for each node). FIG. 6 illustrates the population of the region to which each node belongs as an example of the demand prediction source data. In the present embodiment, the population of each node is used as a prediction source of the probability that each node will be selected as the endpoints of the path. This is because it is considered that a place with a larger population is more likely to be designated as a path endpoint. That is, it is considered that a path is more likely to be set between cities with relatively large populations.

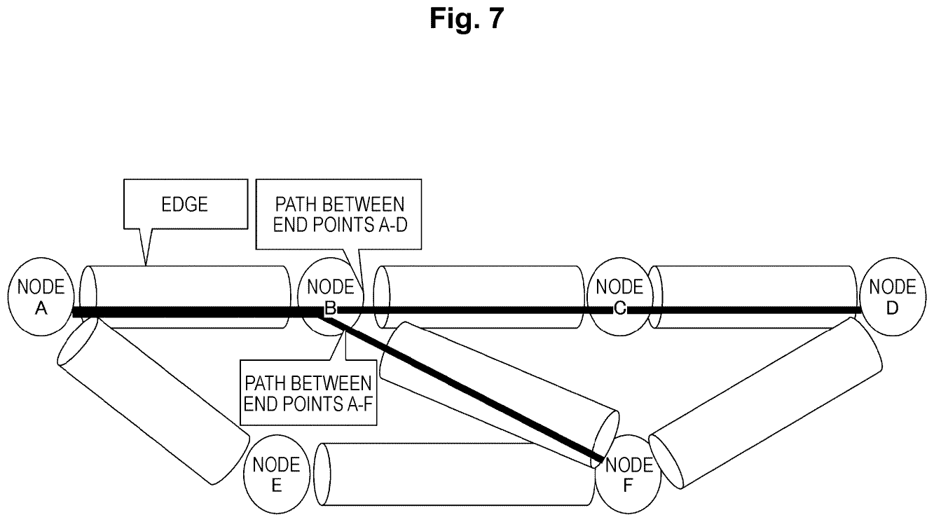

Note that the path is a logical communication route connecting two nodes through one or more edges (physical lines). FIG. 7 is a diagram for explaining a relationship between an edge and a path.

In FIG. 7, an edge is represented by a cylinder, and a path is represented by a solid line. FIG. 7 illustrates two paths. One is a path connecting node A and the node D, and its route is A-B-C-D. The other is a path connecting node A and the node F, and its route is A-B-F.

To establish a communication route using a path, a user of the network designates two endpoints (two nodes) of the path and issues an order.

Subsequently, the initialization unit 11 acquires simulation parameters from the parameter storage unit 122 (S103).

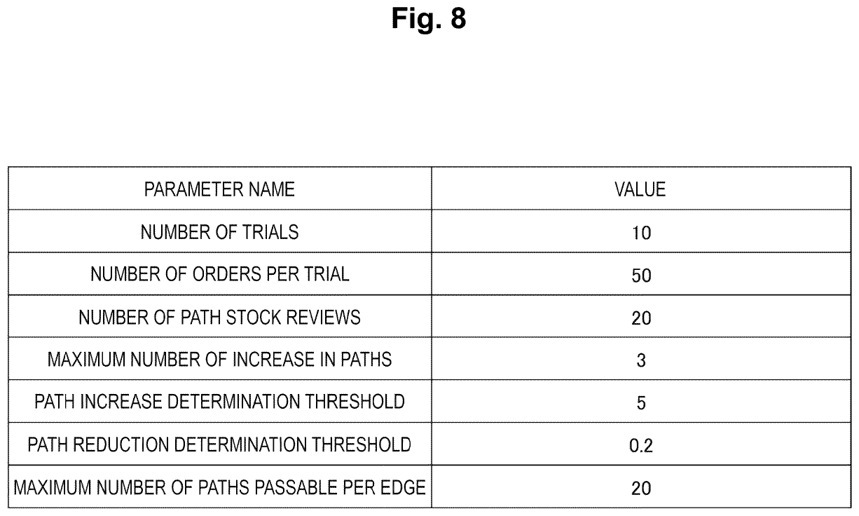

FIG. 8 is a diagram illustrating simulation parameters. The simulation parameter is a parameter for control such as a threshold used in the subsequent processing. Details of each parameter will be described when each parameter is used.

Subsequently, the initialization unit 11 sets the secured number for a pair of two adjacent nodes (hereinafter, a pair of two nodes is referred to as a “node pair”) in the network information (FIG. 4) to 1 (S104). A pair of adjacent nodes (hereinafter referred to as an “adjacent node pair”) refers to a pair of two nodes connected by one edge. The secured number is a parameter constituting data recorded and held for each node pair (hereinafter referred to as “recorded data”), and is the number of transmission paths to be secured in advance between two nodes related to the node pair. The secured number is an initial value of the stocked number of paths to be updated for a node pair related to a path used in a trial. The stocked number of paths for a certain node pair refers to the number of times the path between the node pair can be used as a route for a path corresponding to a path order (hereinafter referred to as an “ordered path”). That is, the stocked number of paths for a certain node pair refers to the number of paths virtually set between the node pair.

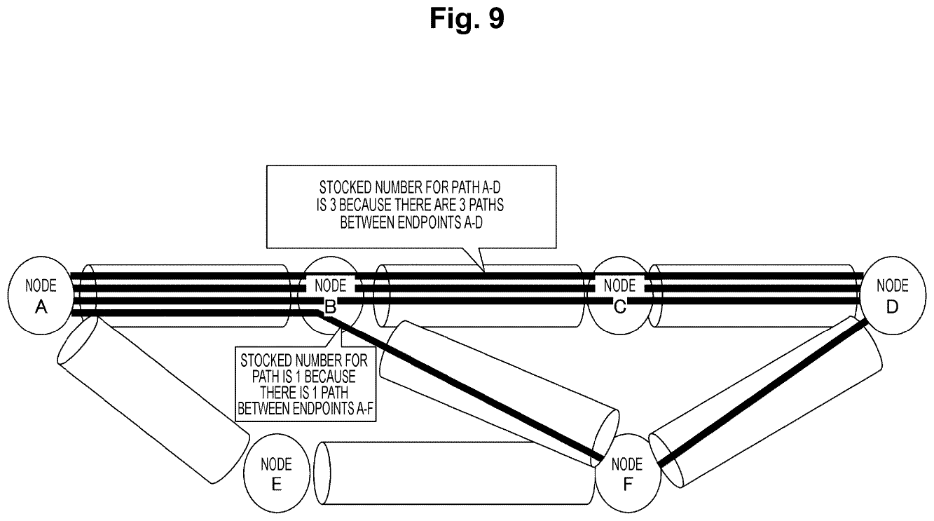

FIG. 9 is a diagram for explaining the stocked number of paths. FIG. 9 illustrates that the number of paths between the node pair A-D is 3 and the number of paths between the node pair A-F is 1. In this case, the stocked number of paths between the node pair A-D is 3, and the stocked number of paths between the node pair A-F is 1.

In step S104, the initialization unit 11 sets the secured number for each of node pairs other than the adjacent node pair to 0. The node pairs other than the adjacent node pair refer to node pairs excluding the adjacent node pair among all the node pairs in the target network. When the number of nodes in the target network is n, all the node pairs in the target network are ₙC₂ node pairs. That is, in the present embodiment, the starting and ending points of the path (the order of nodes in the node pair) are not distinguished. The pair of node A and node B and the pair of node B and node A are treated as the same node pair. Note that all the node pairs in the target network are the set of pairs of nodes that may be designated as both endpoints of the path in the path order.

Subsequently, the initialization unit 11 initializes the used number and shortage number for each node pair to 0 (S105). The used number and the shortage number are also parameters constituting recorded data, which is recorded for each node pair together with the stocked number and updated in the simulation. The used number refers to the number of times a path between a node pair is used for a path order generated in the simulation. The shortage number refers to the number of times the ordered path cannot be connected because there is no path stock between the node pair (the stocked number of paths=0).

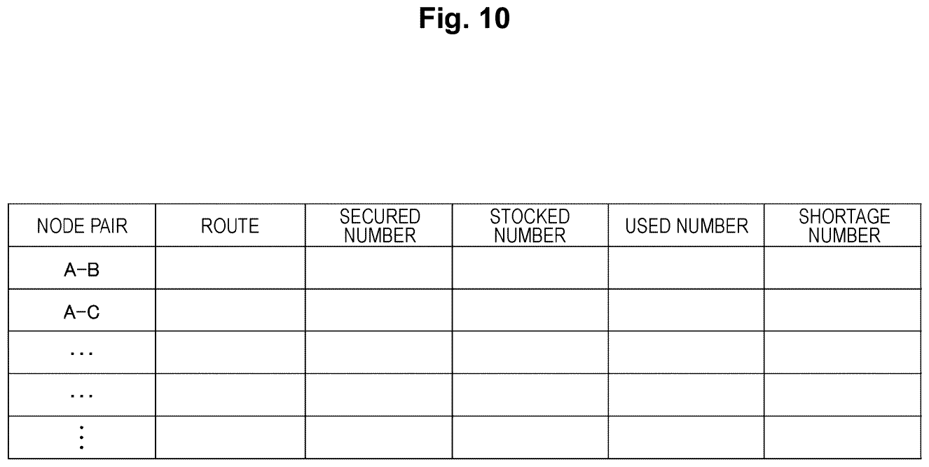

FIG. 10 is a diagram illustrating a configuration example of the recorded data storage unit 124. In FIG. 10, the recorded data storage unit 124 stores the secured number, the stocked number, the used number, and the shortage number for each node pair. The recorded data storage unit 124 also stores the route of the path for each node pair for which the secured number of paths is 1 or more. The route of the path is represented by a sequence of nodes through which the path passes. In the present embodiment, the route of one path is the shortest route between two nodes to which the path is connected.

When step S105 is completed for the first time, the recorded data is in a state in which the secured number, the used number, and the shortage number are initialized.

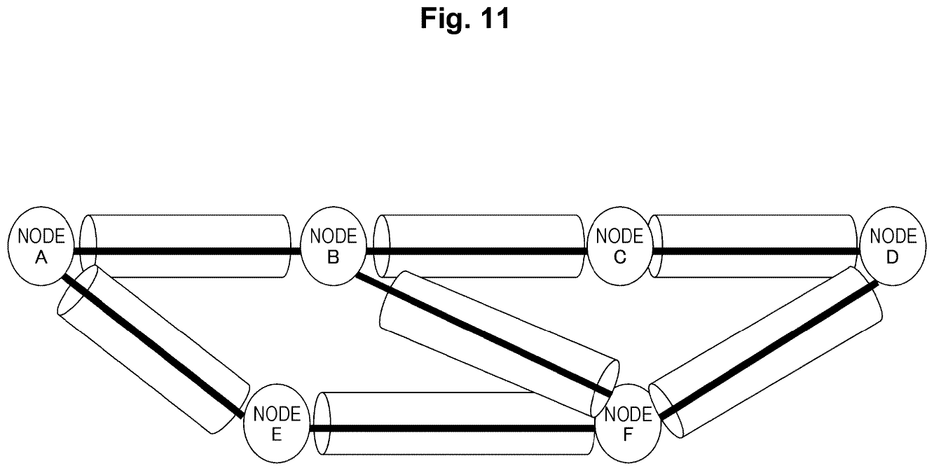

Subsequently, the initialization unit 11 substitutes the stocked number for every node pair with the secured number for the node pair (S106). Therefore, the stock status of each node pair in the target network is as illustrated in FIG. 11. That is, if step S106 is executed for the first time, the stocked number of paths for the adjacent node pair is 1, and the stocked number of paths for the node pair other than the adjacent node pair is 0. The reason why the state in which the stocked number of paths for the adjacent node pair is 1 is set to the initial state is that, since the path between the adjacent nodes is frequently used, the improved efficiency of the simulation can be expected by presetting the stocked number to 1 or more. Note that the initial value of the secured number for each node pair (=the initial value of the stocked number) may differ from the above. The secured number for each node pair may be randomly set or may be 0.

Subsequently, the order generation unit 12 probabilistically generates one path order based on the demand prediction source data (FIG. 6) (S107). The probabilistic generation of one path order is synonymous with the probabilistic selection of one node pair. The probabilistic selection of one node pair refers to probabilistically selecting two nodes different from each other from among a plurality of nodes in the target network. The demand prediction source data (FIG. 6) is used at the time of selecting two nodes. That is, the order generation unit 12 selects two nodes using the population for each node indicated by the demand prediction source data (FIG. 6) as a probability distribution. Hereinafter, a node pair related to the generated path order is referred to as an “ordered pair”.

Subsequently, the route search unit 13 searches for a route that can connect between the ordered pair using only the path stock (S108). For example, the route search unit 13 searches for the shortest route between the ordered pair under the constraint condition that the route passes only between two nodes for which the stocked number of paths is 1 or more.

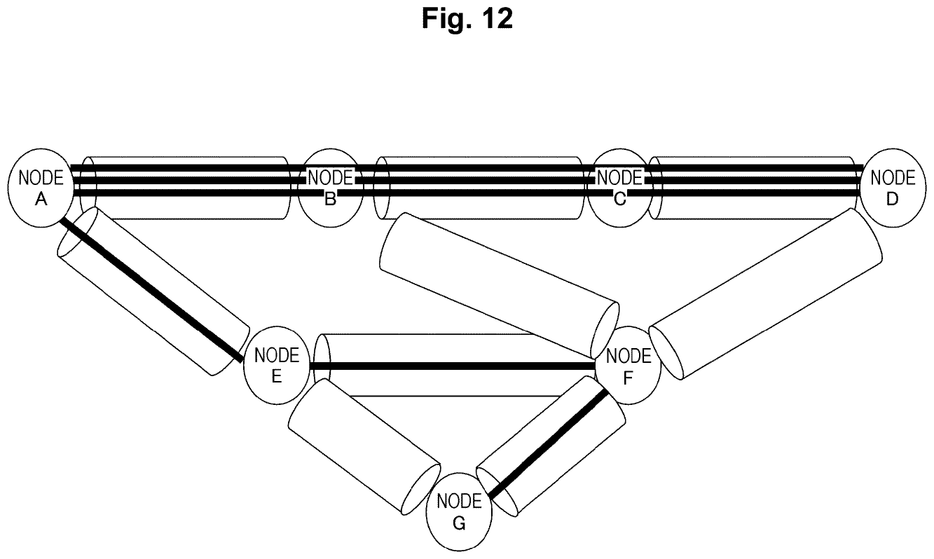

FIG. 12 is a diagram for describing the route search using only the path stock. In FIG. 12, a solid line indicates a path stock. If A-G is designated as the ordered pair, path A-G can be provided using only the path stock in the case of route A-E-F-G (by connecting paths A-E, E-F, and F-G). Therefore, in this case, A-E-F-G is searched as the corresponding route (i.e., ordered path).

If the search for the corresponding route (ordered path) has succeeded (Yes in S109), the route search unit 13 updates the used number and the shortage number for the node pair related to each path used for the ordered path (S110). Specifically, the route search unit 13 adds 1 to the used number for the node pair and subtracts 1 from the stocked number for the node pair. In the case of the example of FIG. 12, 1 is added to the used number for each of the node pairs A-E, E-F, and F-G, and 1 is subtracted from the stocked number for each of the node pairs A-E, E-F, and F-G.

On the other hand, if the search for the corresponding route (ordered path) has failed (No in S109), the route search unit 13 searches for the shortest route between the ordered pair without providing the constraint condition that only the path stock is used (S111). Subsequently, the route search unit 13 adds 1 to the shortage number for the node pair for which the stocked number is 0 among all the node pairs in the set of nodes constituting the above shortest route (hereinafter referred to as “stock shortage route”) (S112). That is, 1 is added to the shortage number for the node pair that has caused the failure of the ordered path connection.

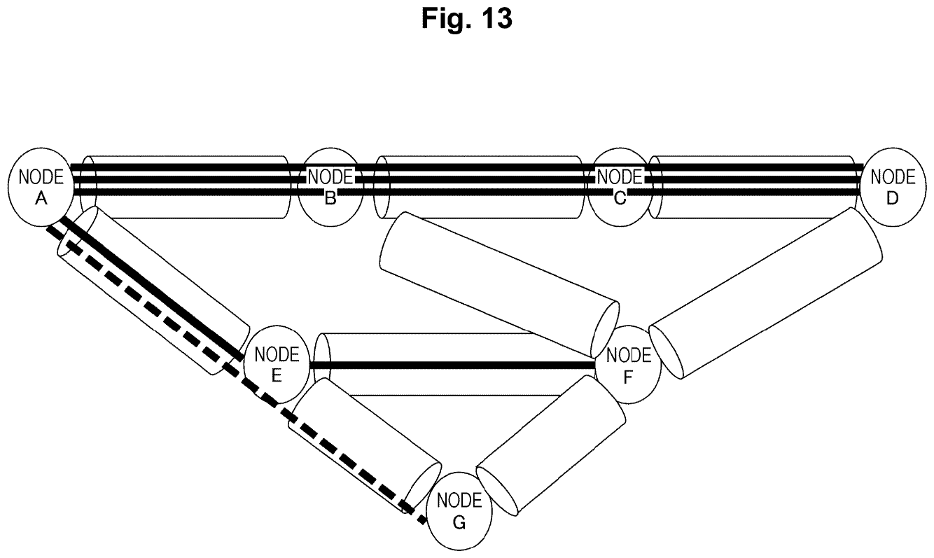

FIG. 13 is a diagram for explaining a path shortage. In FIG. 13, a solid line indicates a path stock. If A-G is designated as the path order, in the state of FIG. 13, the route between A-G cannot be searched using only the path stock. Therefore, the shortest route between A-G is searched for. When the path indicated by the dashed line (A-E-G) is searched for as the shortest route between A-G, all the node pairs in the set of nodes constituting the shortest route (stock shortage route) are {A-E, E-G, A-G}. Among these pairs, the node pairs for which the stocked number is 0 are E-G and A-G. That is, if the node pair E-G or A-G had a path stock, it would have been possible to search for path A-G using only the path stock. Thus, in this case, 1 is added to the shortage number for the node pair E-G or A-G.

Following step S110 or S112, the order generation unit 12 determines whether the specified number of orders has been generated (S113). The specified number of orders refers to the “number of orders per trial” of the simulation parameter (FIG. 8) and is 50 in the present embodiment. That is, in the present embodiment, 50 orders are processed in one trial. Therefore, in this case, the order generation unit 12 determines whether step S107 and the subsequent steps have been repeated 50 times. Note that the number of generated orders is initialized to 0 at the start of the trial (at the timing of step S106).

If the specified number of orders has not been generated (No in S113), step S107 and the subsequent steps are repeated. If the specified number of orders has been generated (Yes in S113), the secured number adjustment unit 14 determines whether the number of executions of the trial (after step S106) has reached the “number of trials” of the simulation parameter (FIG. 8) (S114). According to FIG. 8, the “number of trials” of the present embodiment is 10. Therefore, it is determined whether step S106 and the subsequent steps have been repeated 10 times. Note that the number of executions of the trial is initialized to 0 before the start of the trial (at the timing of step S105). If the number of executions of the trial is less than the “number of trials” (No in S114), step S106 and the subsequent steps are repeated. At this time, the stocked number is initialized using the secured number in step S106, but neither the used number nor the shortage number is initialized. That is, each of the used number and the shortage number becomes a cumulative value of the 10 trials. Therefore, the used number for a certain node pair is the number of ordered paths that have used the path stock of the node pair among the ordered paths searched for in the 10 trials. On the other hand, the shortage number for a certain node pair is a value indicating a shortage of the secured number for the node pair with respect to the number of stock shortage routes passing through the node pair among the stock shortage routes searched for in the 10 trials.

If the number of executions of the trial is less than the “number of trials” (No in S114), the trials in and after step S106 are repeated. If the number of executions of the trial reaches the “number of trials” (Yes in S114), the secured number adjustment unit 14 executes a loop process L1 including steps S115 to S119 for every node pair. The node pair to be processed in the loop process L1 is hereinafter referred to as a “target pair”.

In step S115, the secured number adjustment unit 14 determines whether the secured number for the target pair is 1 or more. If the secured number for the target pair is 1 or more (Yes in S115), the secured number adjustment unit 14 determines whether the usage rate of the target pair is equal to or less than a path reduction determination threshold (S116). The path reduction determination threshold is a threshold preset as the simulation parameter (FIG. 8), and is 0.2 in the present embodiment. The usage rate of the target pair is calculated by the following equation:

$$Usage rate of target pair = Used number for target pair \text{} / ( Secured number for target pair \times Number of trials ) .$$

For example, assume that the used number for the target pair is 1 and the secured number for the target pair is 6. Since the number of trials is 10 in the present embodiment, the usage rate of the target pair in this case is as follows:

$$Usage rate of target pair = 1 / ( 6 \times 10 ) = 0.0166 …$$

If the usage rate of the target pair is equal to or less than the path reduction determination threshold (if the number of ordered paths passing through the target pair is small enough to satisfy a predetermined condition with respect to the secured number for the target pair) (Yes in S116), the secured number adjustment unit 14 reduces the secured number for the target pair (S117). In the present embodiment, the secured number for the target pair is reduced by 1. This is because the secured number for the target pair may be excessive. In this case, steps S118 and S119 are not executed for the target pair.

On the other hand, if the secured number for the target pair is less than 1 (No in S115) or the usage rate of the target pair exceeds the path reduction determination threshold (No in S116), the secured number adjustment unit 14 determines whether the shortage number for the target pair exceeds a path increase determination threshold (S118). The path increase determination threshold is a threshold preset as the simulation parameter (FIG. 8), and is 5 in the present embodiment. If the shortage number for the target pair is equal to or less than the path increase determination threshold (No in S118), step S119 is not executed for the target pair.

If the shortage number for the target pair exceeds the path increase determination threshold (i.e., if the stock shortage route passing through the target pair are greater than the secured number for the target pair, exceeding the path increase determination threshold) (Yes in S118), the secured number adjustment unit 14 increases the secured number for the target pair by up to m (with the maximum number of s) within the range of the edge capacity limit (S119). Here, the value of m is as follows:

$$m = Shortage number for target pair \text{} / Path increase determination threshold$$

The value of s is the “maximum number of increase in paths” preset as the simulation parameter (FIG. 8), and is 3 in the present embodiment.

Furthermore, “within the range of the edge capacity limit” refers to not exceeding “the maximum number of paths passable per edge”, preset as the simulation parameter (FIG. 8), in all the edges belonging to the route for the target pair. According to FIG. 8, in the present embodiment, “the maximum number of paths passable per edge” is 20. For example, in FIG. 9, when the target pair is A-D, the remaining capacity is 17 for B-C and C-D, but the remaining capacity is 16 for A-B, so that 16 is a value within the range of the edge capacity limit. Note that the remaining capacity of a certain edge is obtained by subtracting “the secured number for the edge” from “the maximum number of paths passable per edge”.

For example, when the path increase determination threshold is 5 and the shortage number is 24, the following holds:

$$m = 24 ( shortage number ) / 5 ( path increase determination threshold ) = 4 ( rounded down to the nearest whole number ) .$$

However, when the “maximum number of increase in paths” is 3, the increase in secured number is 3. Furthermore, when the remaining capacity of any edge belonging to the route for the target pair is 2, the increase in secured number is 2.

It is also conceivable to set: m=(shortage number−path increase determination threshold), but in this case, there is a possibility that the secured number increases at once. In the present embodiment, to gradually increase the secured number by repeating trials, the increase is moderated by performing division.

As described above, in the loop process L1, the secured number for the node pair with excess paths is reduced, and the secured number for the node pair with insufficient paths is increased.

When the loop process L1 is executed for every node pair, the secured number adjustment unit 14 determines whether the number of executions (the number of repetitions) of a stock review process has reached a specified number of reviews (S120). Here, the repetition of the loop process L1 related to every node pair corresponds to one execution of the stock review process. Thus, the number of executions of the stock review process when step S120 is executed for the first time is 1. The specified number of reviews is the “number of path stock reviews” preset as the simulation parameter (FIG. 8), and is 20 in the present embodiment.

If the number of executions of the stock review process is less than the specified number of reviews (No in S120), step S105 and the subsequent steps are repeated. Therefore, the used number and the shortage number for every node pair are initialized to 0 again (S105), the stocked number for every node pair is initialized using the secured number (S106), and step S107 and the subsequent steps are repeated. That is, in the present embodiment, the trial, including 50 times of order generation, is repeated 10 times, and the path stock review process for each set of 10 trials is further repeated 20 times. Therefore, the order generation is performed 50×10×20=10,000 times, and the trial is performed 10×20=200 times.

The secured number can change with each stock review process, and hence, the secured number for each node pair can differ from the previous one in the subsequent step S106. That is, the secured number adjusted based on the past trials is used as the initial value of the stocked number in the next 10 trials.

If the number of executions of the stock review process is equal to or greater than the specified number of reviews (Yes in S120), the output unit 15 outputs the route and the secured number for each of the ₙC₂ node pairs as a result of the simulation (S121).

The user who has obtained such an output can, based on the output, perform path presetting (pre-order setting) on the target network. The route of the path is the route (shortest route) output for the node pair. The secured number for each node pair is the number of paths that need to be secured in advance between each node pair based on the demand prediction of the order. Thus, the secured number is considered to indicate the likelihood of actual orders (or a predicted value of the number actually ordered). Therefore, for each node pair, the user may preset paths corresponding to the secured number for each node pair in the target network. Alternatively, the user may treat the secured number for each node pair as a ratio, and preset the number of paths corresponding to the ratio of the secured number between each node pair. At this time, the user may perform presetting only for the node pair for which the secured number is equal to or greater than a threshold. By performing such presetting, it is possible to rapidly handle two nodes designated in the actual path order. This is because there is a possibility that the path between the two nodes has already been set. Even if the path between the two nodes is not set, the already set path can be connected to provide the path between the two nodes. Even in this case, it is possible to provide the path more rapidly than a case where the path is set from the beginning after receipt of the path order.

In addition, the efficiency in resource utilization can be improved more than in a full mesh.

As described above, according to the present embodiment, it is possible to support in improving the efficiency in the provision of a network transmission path. For example, it is possible to support in rapidly providing a transmission path for any path order of the user. It is also possible to limit the amount of available resources in accordance with the network requirements (the maximum number of paths passable per edge) and to prevent excessive resource securing.

Rapid provision of the path enables utilization of a temporary alternative path when the transmission path fails. For example, a combination of immediately providable paths can be searched for between two points where a failure has occurred, enabling the combination of paths to be used and switched back to the original paths after failure recovery.

The utilization is also possible to increase the path speed. For example, if the bandwidth of an existing path in use is insufficient, a combination of paths with higher bandwidth can be searched for, and switching can be made to the combined path, thereby immediately transitioning to a higher-speed path.

Although the present embodiment has shown an example of selecting paths easily used by the Monte Carlo method, another method may be adopted as the path selection algorithm.

In the present embodiment, the order generation unit 12 is an example of a selection unit.

Although the embodiment of the present invention has been described in detail above, the present invention is not limited to such a specific embodiment, and various modifications and changes can be made within the scope of the gist of the present invention described in the claims.

### REFERENCE SIGNS LIST

10 Path provision support apparatus
11 Initialization unit
12 Order generation unit
13 Route search unit
14 Secured number adjustment unit
15 Output unit
100 Drive device
101 Recording medium
102 Auxiliary storage device
103 Memory device
104 Processor
105 Interface device
121 Network information storage unit
122 Parameter storage unit
123 Demand prediction source data storage unit
124 Recorded data storage unit
B Bus

1. A path provision support apparatus comprising:
a processor; and
a memory that includes instructions, which when executed, cause the processor to execute:
selecting, by probabilistic selection, a plurality of pairs of first two nodes from among a plurality of nodes in a physical network, based on data indicating a likelihood of each of the plurality of nodes being selected as an endpoint of a logical transmission path set in the physical network;
searching, for each of the pairs of first two nodes, for a route capable of connecting the pair of first two nodes in the physical network; and
changing a secured number that is the number of transmission paths to be secured in advance, for a pair of second two nodes through which the routes pass by a number satisfying a predetermined condition among all pairs of second two nodes out of the plurality of nodes.

2. The path provision support apparatus according to claim 1, wherein, for the pair of second two nodes through which the routes pass by a number greater than the secured number for the pair of second two nodes, exceeding a threshold, the changing includes increasing the secured number.

3. The path provision support apparatus according to claim 2, wherein
the searching includes searching for a route capable of connecting the pair of first two nodes by using only a stock of the secured number of transmission paths for the pair of second two nodes, and searching for, for the pair of first two nodes for which a route using only the stock has not been able to be searched, a shortest route capable of connecting the pair of first two nodes, and
for the pair of second two nodes through which the shortest route passes by a number greater than the secured number for the pair of second two nodes, exceeding a threshold, the changing includes increasing the secured number.

4. The path provision support apparatus according to claim 3, wherein the searching includes further searching for the route or the shortest route for each of the plurality of pairs of first two nodes selected by the selection unit after the secured number for one of the pairs of second two nodes has been changed by the secured number adjustment unit, using the secured number for the pair of second two nodes as an initial value of a stocked number of transmission paths for the pair of second two nodes.

5. The path provision support apparatus according to claim 1, wherein the changing includes reducing the secured number for the pair of second two nodes through which the routes pass by a number small enough to satisfy a predetermined condition with respect to the secured number for the pair of second two nodes.

6. A path provision support method causing a computer to execute:
selecting, by probabilistic selection, a plurality of pairs of first two nodes from among a plurality of nodes in a physical network, based on data indicating a likelihood of each of the plurality of nodes being selected as an endpoint of a logical transmission path set in the physical network;
searching, for each of the pairs of first two nodes, for a route capable of connecting the pair of first two nodes in the physical network; and
changing a secured number that is the number of transmission paths to be secured in advance, for a pair of second two nodes through which the routes pass by a number satisfying a predetermined condition among all pairs of second two nodes out of the plurality of nodes.

7. A non-transitory computer-readable recording medium having computer-readable instructions stored thereon, which when executed, cause a computer to execute:
selecting, by probabilistic selection, a plurality of pairs of first two nodes from among a plurality of nodes in a physical network, based on data indicating a likelihood of each of the plurality of nodes being selected as an endpoint of a logical transmission path set in the physical network;
searching, for each of the pairs of first two nodes, for a route capable of connecting the pair of first two nodes in the physical network; and
changing a secured number that is the number of transmission paths to be secured in advance, for a pair of second two nodes through which the routes pass by a number satisfying a predetermined condition among all pairs of second two nodes out of the plurality of nodes.
